(19) United States
(12) Patent Application Publication
(10) Pub. No.: US 2015/0084518 A1
(43) Pub. Date: Mar. 26, 2015

(54) Lighting Control System

(71) Applicant: Toshiba Lighting & Technology Corporation, Yokosuka-shi (JP)

(72) Inventor: Junko Takahashi, Yokosuka-shi (JP)

(73) Assignee: TOSHIBA LIGHTING & TECHNOLOGY CORPORATION, Yokosuka-shi (JP)

(21) Appl. No.: 14/196,390

(22) Filed: Mar. 4, 2014

(30) Foreign Application Priority Data
Sep. 20, 2013 (JP) 2013-196178

(51) Int. Cl. H05B 37/02

(52) U.S. Cl. CPC H05B 37/0236; H05B 37/0227
USPC 315/152; 315/297

(57) ABSTRACT

According to one embodiment, a lighting control system includes: a plurality of lighting apparatuses, a sound sensor and a control device. The plurality of lighting apparatuses illuminate a predetermined space. The sound sensor is disposed in the predetermined space and detects a voice of a person in the space. The control device is connected to the plurality of lighting apparatuses and the sound sensor, and controls at least one of a light color and a dimming degree of the plurality of lighting apparatuses depending on quality of the voice of the person that is detected by the sound sensor.

### CROSS-REFERENCE TO RELATED APPLICATIONS

This application is based upon and claims the benefit of priorities from Japanese Patent Application No. 2013-196178 filed on Sep. 20, 2013; the entire contents of which are incorporated herein by reference.

### FIELD

Embodiments described herein relate generally to a lighting control system.

### BACKGROUND

In recent years, various and fine control of a lighting apparatus can be performed as a lighting device such as a Light Emitting Diode (LED) is developed. For example, a lighting system is known which can variously change the lighting apparatus including a plurality of LED lamps capable of emitting multiple colors according to music.

However, in a lighting control system of the related art, lighting control suitable for a number of persons present in a room, mood, atmosphere or the like cannot be realized.

### BRIEF DESCRIPTION OF THE DRAWINGS

FIG. 1 is a diagram illustrating an example of a configuration of a lighting control system according to a first embodiment;

FIG. 2 is a diagram illustrating an example of a configuration of a control device included in the lighting control system of the first embodiment;

FIG. 3 is a table illustrating an example of a configuration of information stored in a control pattern storage section according to the first embodiment;

FIG. 4 is a flowchart illustrating an example of a flow of a lighting control processing according to the first embodiment;

FIG. 5 is a table illustrating an example of a configuration of information stored in a control pattern storage section according to a modification example of the first embodiment;

FIG. 6 is a diagram illustrating an example of a configuration of a lighting control system according to a second embodiment;

FIG. 7 is a diagram illustrating an example of a configuration of a control device according to the second embodiment;

FIG. 8 is a table illustrating an example of a configuration of information stored in a control pattern storage section according to the second embodiment; and

FIG. 9 is a flowchart illustrating an example of a flow of a lighting control processing according to the second embodiment.

### DETAILED DESCRIPTION

According to an embodiment, a lighting control system includes a plurality of lighting apparatuses, a sound sensor and a control device. The plurality of lighting apparatuses illuminate a predetermined space. The sound sensor is disposed in the predetermined space and detects a voice of a person in the space. The control device is connected to the plurality of lighting apparatuses and the sound sensor, and controls at least one of a light color and a dimming degree of the plurality of lighting apparatuses depending on quality of the voice of the person that is detected by the sound sensor.

The control device that is included in the lighting control system may perform control of at least one of the light color and the dimming degree of the plurality of lighting apparatuses, when a sound pressure level of the voice of the person that is detected by the sound sensor is a continuous predetermined value for a predetermined period.

The control device that is included in the lighting control system may perform control to lower the dimming degree of the plurality of lighting apparatuses, when the sound pressure level of the voice of the person that is detected by the sound sensor is smaller than a first threshold, and may perform control to increase the dimming degree of the plurality of lighting apparatuses, when the sound pressure level of the voice of the person that is detected by the sound sensor is greater than a second threshold that is greater than the first threshold.

The control device that is included in the lighting control system may perform control to lower a color temperature of the light color of the plurality of lighting apparatuses, and to lower the dimming degree of the plurality of lighting apparatuses when the sound pressure level of the voice of the person that is detected by the sound sensor is greater than a third threshold that is greater than the second threshold.

The control device that is included in the lighting control system may calculate a number of persons present in the predetermined space from the voice of the person that is detected by the sound sensor and may control at least one of the light color and the dimming degree of the plurality of lighting apparatuses based on the sound pressure level of the voice and the number of persons that is calculated.

The lighting control system may further include: an image sensor that acquires an image in the predetermined space, in which the control device may calculate an activity amount in the predetermined space, based on the image that is acquired by the image sensor, and may control at least one of the light color and the dimming degree of the plurality of lighting apparatuses, depending on the activity amount and the sound pressure level of the voice of the person that is detected by the sound sensor.

The lighting control system may further include: an image sensor that acquires an image in the predetermined space, in which the control device may calculate a number of persons in the predetermined space, based on the image that is acquired by the image sensor, and may control at least one of the light color and the dimming degree of the plurality of lighting apparatuses, depending on the number of persons and the sound pressure level of the voice of the person that is detected by the sound sensor.

The control device that is included in the lighting control system may specify emotion indicated by the voice, based on at least one of a frequency, an amplitude and a waveform of the voice of the person that is detected by the sound sensor, and may perform control of at least one of the light color and the dimming degree of the plurality of lighting apparatuses, depending on the specified emotion.

Hereinafter, embodiments of the lighting control system are described with reference to the drawings. In the embodiments, the same reference numerals are given to configurations having the same functions and duplicate description is omitted.

### First Embodiment

A lighting control system according to a first embodiment detects person's voice in a room and performs control of a light color or a dimming degree of a lighting apparatus, based on quality of the voice that is detected.

Illumination affects on a person mind and body is well known. For example, the illumination of a warm color or indirect illumination makes a person relax and get him/her into a calm mood. On the other hand, the illumination of slightly cool white color has an effect to increase concentration of a person.

The lighting control system according to the first embodiment detects voice of a person in a predetermined space, estimates a mood of the person in the space from the voice that is detected and determines, and executes control content of the illumination suitable for the mood.

### One Example of Configuration of Lighting Control System According to First Embodiment

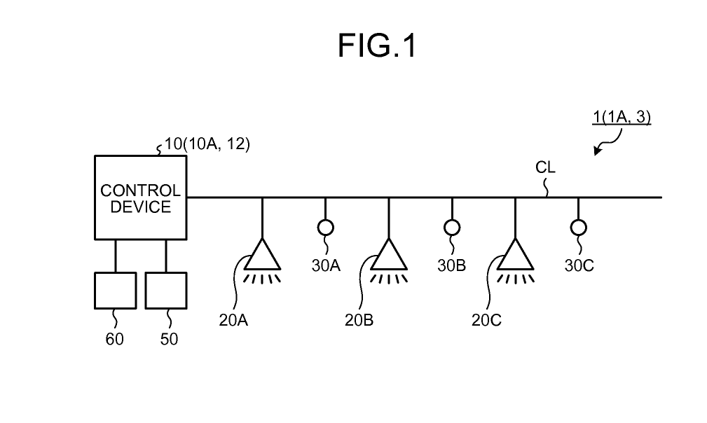

FIG. 1 is a diagram illustrating an example of a configuration of a lighting control system according to a first embodiment. As illustrated in FIG. 1, a lighting control system 1 according to the first embodiment includes a control device 10, a plurality of lighting apparatuses 20A, 20B and 20C, and a plurality of sound sensors 30A, 30B and 30C. The control device 10 is connected to the plurality of lighting apparatuses 20A, 20B and 20C, and the plurality of sound sensors 30A, 30B and 30C by a communication line CL. Further, the control device 10 is connected to a wall switch 50. Further, the control device 10 is detachably connected to an information processing device 60.

The control device 10 receives sound information detected by the sound sensors 30A, 30B and 30C through the communication line CL and controls an operation of the lighting apparatuses 20A, 20B and 20C, based on the received sound information. For example, the control device 10 controls a light color or a dimming degree of the lighting apparatuses 20A, 20B and 20C depending on a loudness (amplitude), a pitch (frequency), a timbre (waveform) or the like of the sound detected by the sound sensors 30A, 30B and 30C. Particularly, in the first embodiment, the control device 10 controls the light color or the dimming degree of the lighting apparatuses 20A, 20B and 20C depending on the loudness of the sound, that is, a sound pressure (P) or a sound pressure level (dB).

For example, the lighting apparatuses 20A, 20B and 20C are lighting lamps such as Light Emitting Diode (LED) which are provided on a ceiling surface in a room or the like and illuminate in the room. The lighting apparatuses 20A, 20B and 20C are controlled by the control device 10 and the light color or the dimming degree is changed. For example, the lighting apparatuses 20A, 20B and 20C can be switched to the light color such as a daylight color, a daytime white color, or a lamp color, or the light color that is formed by mixing the light of red, green and blue in those colors. Here, the daylight color is referred to the light of which a color temperature is relatively high, for example, approximately 6500 K of the color temperature, the daytime white color is referred to the light of which the color temperature is approximately 5000 K, and the lamp color is referred to as the light of which the color temperature is relatively low, for example, approximately 3000 K. Further, the lighting apparatuses 20A, 20B and 20C can change the dimming degree in a range of 0% to 100%.

Moreover, in FIG. 1, three lighting apparatuses are illustrated, but the number of the lighting apparatuses that are provided is not particularly limited. Further, in the first embodiment, the control device 10 uniformly controls operation of the lighting apparatuses 20A, 20B and 20C, but the lighting apparatus may have a part of control function of the control device 10 and autonomous control may be performed.

The sound sensors 30A, 30B and 30C are provided on the ceiling surface or the like in the room and detect sound in the room. The sensor that may be used as the sound sensors 30A, 30B and 30C is not particularly limited if the sensor can detect person's voice in the room. For example, a microphone is provided on the ceiling surface or the like and can be used as the sound sensors 30A, 30B and 30C. Further, if it is always provided in the room, a microphone built in a personal computer (PC) or the like can also collect the sound information by connecting to the control device 10 wirelessly as the sound sensors 30A, 30B and 30C. Moreover, in FIG. 1, three sound sensors are illustrated, but the number of the sound sensors is an example and the number of the sound sensors which are provided is not particularly limited, and may be one or four or more, as long as it can detect a voice that allows collection of information of the number of persons present in the room, mood, atmosphere or the like.

Moreover, in the first embodiment, the control device 10 extracts the person's voice from the sound detected by the sound sensors 30A, 30B and 30C and performs the lighting control, based on person's voice information. A method for extracting the person's voice from the sound including noise is not particularly limited. For example, it is possible to use a method of filtering a predetermined band by performing frequency analysis or the like.

The wall switch 50 is a switch that is used for performing the control of light on, light off, dimming or the like of the lighting apparatus by a user. The wall switch 50 may be disposed in an arbitrary location as long as the user can easily operate the switch at the location. The wall switch 50 is connected to the control device 10 and transmits ON-OFF signals to the control device 10.

The information processing device 60 is an information terminal such as a general purpose computer that can be commonly available. For example, the personal computer (PC), a smart phone, a tablet computer or the like can be used as the information processing device 60. The user performs input of setting and change of the information by appropriately connecting the information processing device 60 to the control device 10.

### One Example of Configuration of Control Device 10

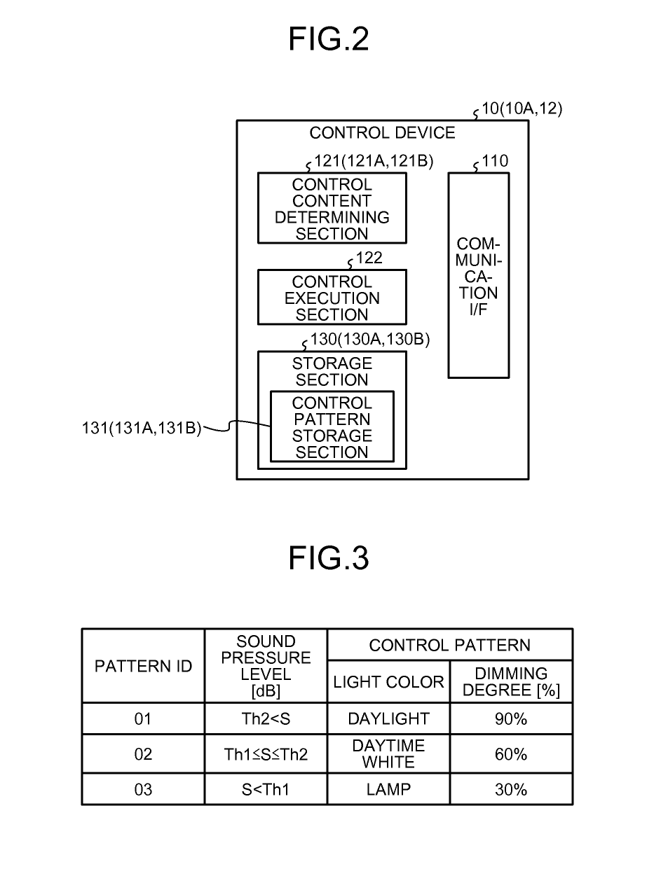

FIG. 2 is a diagram illustrating an example of a configuration of the control device 10 included in the lighting control system 1 according to the first embodiment. As illustrated in FIG. 2, the control device 10 includes a communication interface 110, a control content determining section 121, a control execution section 122, and a storage section 130.

The communication interface 110 receives the information from the lighting apparatuses 20A, 20B and 20C, and the sound sensors 30A, 30B and 30C, and transmits control instruction to the lighting apparatuses 20A, 20B and 20C. Moreover, the communication interface 110 performs receiving and transmitting of the information between the control device 10, the wall switch 50 and the information processing device 60.

The control content determining section 121 analyzes the information received from the sound sensors 30A, 30B and 30C and determines control contents which are executed with respect to the lighting apparatuses 20A, 20B and 20C. Particularly, the control content determining section 121 extracts the sound pressure level of the sound that is detected by the sound sensors 30A, 30B and 30C, and compares it to predetermined thresholds Th1 and Th2. When the sound pressure level is smaller than the predetermined threshold Th1, the control content determining section 121 determines that an activity of the person is small because the room is quiet, and decides to execute the lighting control of contents suitable for a calm atmosphere.

On the other hand, when the sound pressure level is greater than the predetermined threshold Th2, the control content determining section 121 determines that a plurality of persons have lively discussion or the like because the room is busy. Then, the control content determining section 121 determines to execute the lighting control of contents suitable for a bright atmosphere that encourages further lively discussion.

For example, when the sound pressure level is smaller than the threshold Th1, the control content determining section 121 determines the control contents for performing illumination of the calm atmosphere by lowering the illuminance. Further, when the sound pressure level is greater than the threshold Th2, the control content determining section 121 determines the control contents performing the illumination of the bright atmosphere by increasing the illuminance to be suitable for a busy atmosphere. Moreover, as described below, the control content determining section 121 determines the control contents by referring to a control pattern stored in the storage section 130.

The control execution section 122 transmits a control signal that executes the control contents determined by the control content determining section 121 in the lighting apparatuses 20A, 20B and 20C through the communication line CL and executes the lighting control.

The storage section 130 stores information for control of the lighting apparatuses 20A, 20B and 20C by the control device 10. For example, the storage section 130 stores in advance the sound pressure level of the voice that is detected by the sound sensors 30A, 30B and 30C, and the control contents that are executed corresponding to the sound pressure level. Moreover, the user stores a desired control pattern to the storage section 130 by inputting control pattern from the information processing device 60.

The storage section 130 includes a control pattern storage section 131. FIG. 3 is a table illustrating an example of a configuration of information stored in the control pattern storage section 131 according to the first embodiment. As illustrated in FIG. 3, in the first embodiment, the control pattern storage section 131 stores three control patterns. The control pattern that is specified as a pattern Identifier (ID) “01” indicates that the light color is controlled to be “the daylight” color and the dimming degree is controlled to be “90%” when a sound pressure level S [dB] that is detected is greater than the threshold Th2. Further, the control pattern of a pattern ID “02” indicates that the light color is controlled to be “the daytime white” color and the dimming degree is controlled to be “60%” when the sound pressure level S that is detected is equal to the threshold Th1 or greater but does not exceed the threshold Th2. Further, the control pattern of a pattern Identifier (ID) “03” indicates that the light color is controlled to be “the lamp” color and the dimming degree is controlled to be “30%” when the sound pressure level S that is detected is smaller than the threshold Th1.

### One Example of Flow of Lighting Control Processing

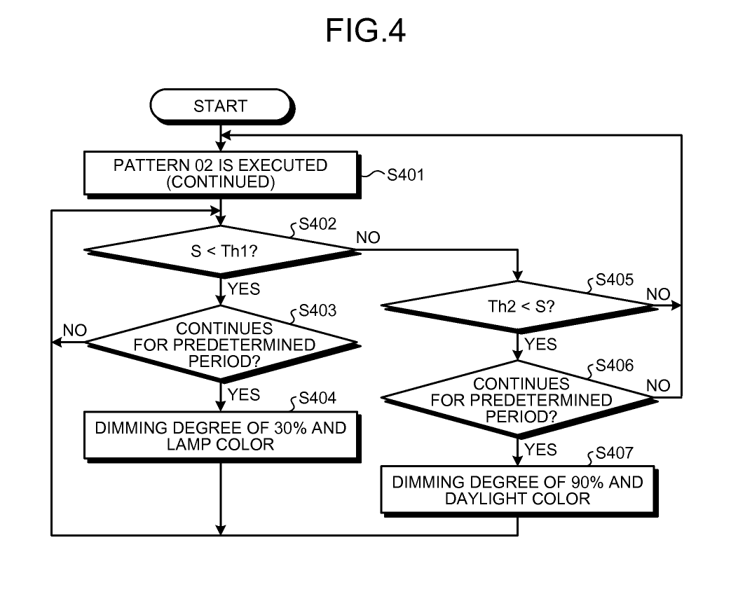

FIG. 4 is a flowchart illustrating an example of a flow of a lighting control processing according to the first embodiment. First, when starting the operation of the lighting control system 1, the control device 10 controls the lighting apparatuses 20A, 20B and 20C with the control pattern of the pattern ID “02” as a default setting (S401). Then, the sound sensors 30A, 30B and 30C detect the sound in the room. The sound information that is detected is transmitted to the control device 10. The control content determining section 121 extracts the sound pressure level S, that is, the loudness of the sound from the sound information that is detected and compares it to the threshold Th1 (S402).

When the sound pressure level S is smaller than the threshold Th1 (S402, Yes), the control content determining section 121 determines whether or not a state where the sound pressure level S that is detected is smaller than the threshold Th1 continues for a predetermined period (S403). For example, the determination of S403 is realized by storing the sound pressure level that is detected previously and a detected time thereof in the storage section 130. When it is determined that the state where the sound pressure level S is smaller than the threshold Th1 continues for a predetermined period (S403, Yes), the control content determining section 121 refers to the control pattern storage section 131 of the storage section 130 and determines the control pattern of the pattern ID “03” corresponding to a sound pressure level “S<Th1” as the control contents which are executed, and reads the control contents (see FIG. 3). Then, the control execution section 122 executes the lighting control to control the light color to be “the lamp” color and the dimming degree to be “30%” (S404).

On the other hand, when the control content determining section 121 determines that the state where the sound pressure level S that is detected is smaller than the threshold Th1 does not continue for a predetermined period (S403, No), the control execution section 122 does not perform the control that changes the state of the lighting apparatuses 20A, 20B and 20C and the processing returns to S402.

Next, the processing returns to S402 and when it is determined that the sound pressure level S that is detected is equal to or greater than the threshold Th1 (S402, No), thereafter, the control content determining section 121 determines whether or not the sound pressure level S is greater than the threshold Th2 (S405).

When it is determined that the sound pressure level S is greater than the threshold Th2 (S405, Yes), thereafter, the control content determining section 121 determines whether or not the state where the sound pressure level S is greater than the threshold Th2 continues for a predetermined period (S406). When it is determined that the state where the sound pressure level S is greater than the threshold Th2 continues for a predetermined period (S406, Yes), the control content determining section 121 refers to the control pattern storage section 131 of the storage section 130 and determines the control pattern of the pattern ID “01” corresponding to a sound pressure level “Th2<S” as the control contents which are executed, and reads the control contents (see FIG. 3). Then, the control execution section 122 executes the lighting control to control the light color to be “the daylight” color and the dimming degree to be “90%” (S407). The processing returns to S402.

Meanwhile, when the control content determining section 121 determines that the state where the sound pressure level S is greater than the threshold Th2 does not continue for a predetermined period (S406, No), the processing returns to S401.

After the control of S404 and S407 is executed, the processing returns to S402 and thereafter, the control device 10 repeats the determination of the sound pressure level that is detected.

Moreover, in the example of FIG. 4, the determination whether or not the same state continues for a predetermined period is executed and then the dimming control is performed, but the determination may be omitted and the control pattern may be determined and control may be performed directly by executing only comparison of the threshold and the sound pressure level.

Further, in the example of FIG. 4, the control pattern of the pattern ID “02” is executed as the default setting (S401), but the sound pressure level may be determined everytime the user turns on the lighting device and then the control pattern may be determined. Further, the user may set the default setting separately.

Further, when executing the switching of the control pattern, the control device 10 may control the dimming degree to be gradually changed without changing the dimming degree from 30% to 60% or from 90% to 60% at one time. Therefore, the lighting control system 1 can realize a lighting state suitable for the atmosphere in the room without making the person in the room conscious of the lighting control.

Further, in the above description, the control content is determined by comparing the two thresholds Th1 and Th2, and the sound pressure level that is detected. However, it is possible to realize fine control by further setting another threshold. For example, a threshold Th3 that is greater than the threshold Th2 is set and when the sound pressure level S that is detected exceeds the threshold Th3, it is determined that commotion such as fighting is going on or the discussion is too hot in the room, and then the light may be switched to the lamp color that calms the nerves, that is, dark dimming may be performed. As described above, it is possible to realize further fine lighting control by performing the lighting control by setting an additional threshold.

### Effects of First Embodiment

As described above, the lighting control system 1 according to the first embodiment includes the plurality of lighting apparatuses 20A, 20B and 20C that illuminate a predetermined space; the sound sensors 30A, 30B and 30C that are disposed in the predetermined space and detects the person's voice in the space; and the control device 10 that is connected to the plurality of lighting apparatuses 20A, 20B and 20C, and the sound sensors 30A, 30B and 30C, and performs the control of at least one of the light color and the dimming degree of the plurality of lighting apparatuses depending on quality of the person's voice that is detected by the sound sensors. Thus, it is possible to perform the dimming control suitable for the atmosphere by determining the atmosphere in the room from the person's voice in the space.

Further, in the lighting control system 1 according to the first embodiment, when the sound pressure level of the person's voice that is detected by the sound sensors 30A, 30B and 30C is a predetermined value continuously for a predetermined period, the control device 10 performs the control of at least one of the light color and the dimming degree of the plurality of lighting apparatuses 20A, 20B and 20C. Thus, when a state of the voice is changed only temporarily in the room and such a state may be immediately returned to the original state, it is possible to realize the illumination suitable for the mood of the person in the room without changing the lighting state.

In the lighting control system 1 according to the first embodiment, when the sound pressure level of the person's voice that is detected by the sound sensors 30A, 30B and 30C is smaller than the first threshold Th1, the control device 10 performs the control to lower the dimming degree of the plurality of lighting apparatuses 20A, 20B and 20C, and when the sound pressure level of the person voice that is detected by the sound sensors 30A, 30B and 30C is greater than the second threshold Th2 that is greater than the first threshold Th1, the control device 10 performs control to increase the dimming degree of the plurality of lighting apparatuses 20A, 20B and 20C. Thus, the lighting control system 1 can realize the bright illumination suitable for the atmosphere if the room is lively and realize the calm illumination suitable for the calm atmosphere if the room is quiet. Therefore, the lighting control system 1 can easily realize the lighting control suitable for the mood of the person in the room.

Further, in the lighting control system 1 according to the first embodiment, when the sound pressure level of the person's voice that is detected by the sound sensors 30A, 30B and 30C is greater than the third threshold Th3 that is greater than the second threshold Th2, the control device 10 performs control to lower the color temperature of the light color of the plurality of lighting apparatuses 20A, 20B and 20C and to lower the dimming degree of the plurality of lighting apparatuses 20A, 20B and 20C. Thus, the lighting control system 1 can apply different control pattern by distinguishing the state where the discussion is too hot or the state where the sound pressure level increases in the room due to occurrence of fighting from the state where only lively discussion is performed. Thus, the lighting control system 1 can realize the fine lighting control suitable for the mood of the person in the room depending on the sound pressure level.

### Modification Example of First Embodiment

In the first embodiment, the person's voice is detected in the room by the sound sensor and the lighting control is realized, based on the sound pressure level of the voice. In addition to this, the number of persons in the room is detected from the sound information that is detected by the sound sensor and it is possible to realize the lighting control depending on the number of persons and the sound pressure level. An example realizing the lighting control depending on the number of persons and the sound pressure level in the room is described as a modification example.

A configuration of a lighting control system 1A according to the modification example is similar to the lighting control system 1 of the first embodiment (see FIGS. 1 and 2). However, the lighting control system 1A of the modification example is different in that a control device 10A is included instead of the control device 10 of the first embodiment and a control pattern storage section 131A that stores the control pattern depending on the number of persons and the sound pressure level in the room is included in a storage section 130A of the control device 10A.

Further, a control content determining section 121A of the modification example calculates the number of persons present in the room by analyzing the sound information that is received from the sound sensors 30A, 30B and 30C. For example, the control content determining section 121A analyzes a frequency of the sound information that is received from the sound sensors 30A, 30B and 30C, and calculates the number of persons in the room by using an analysis model that is prepared in advance, based on a sample of the person's voice. Then, the control content determining section 121A refers to the control pattern storage section 131A and determines the control pattern corresponding to the number of persons which is calculated and the sound pressure level as an object to be executed.

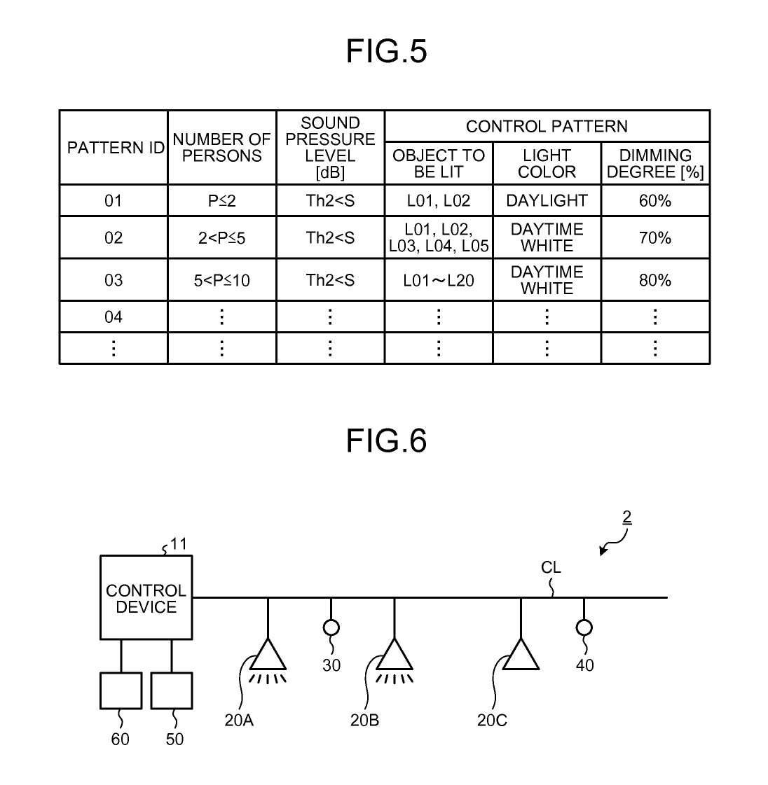

FIG. 5 is a table illustrating an example of a configuration of information that is stored in the control pattern storage section 131A according to the modification example of the first embodiment. The control pattern storage section 131A stores the control pattern depending on the calculated number of persons and the sound pressure level in the room. For example, the control pattern specified as the pattern ID “01” is applied when the number of persons is two or less in the room and the sound pressure level is greater than the threshold Th2. In the control pattern of the pattern ID “01”, two illuminations specified as lighting IDs “L01 and L02” are lit and the light color is “the daylight” color, and the dimming degree is “60%”. As described above, even if the sound pressure level is high, when the number of persons is small in the room, the number of the lightings that are lit is suppressed and the light color is the daylight color having effect of increasing the degree of concentration, and the dimming degree is also suppressed. Further, the control pattern specified as the pattern ID “03” is applied when the number of persons is more than 5 and 10 or less in the room and the sound pressure level exceeds the threshold Th2. In this case, the illumination that is the object to be lit increases to include illuminations specified by the lighting IDs “L01 to L20” and the light color is also “the daytime white” color encouraging a lively discussion and the dimming degree also increases to “80%”.

### Effect of Modification Example

As described above, in the lighting control system according to the modification example of the first embodiment, the control device 10A calculates the number of persons present in a predetermined space from the person's voice that is detected by the sound sensors 30A, 30B and 30C and controls at least one of the light color and the dimming degree of the plurality of lighting apparatuses, based on the sound pressure level of the voice and the number of persons that is calculated. Thus, it is possible to change control contents according to the number of persons in the room even if the sound pressure level is the same, and it is possible to realize the fine lighting control. Further, if the number of persons is small in the room, it is possible to contribute to reduction in power consumption by reducing the number of lighting apparatuses that are the objects to be lit.

### Second Embodiment

The lighting control system according to the first embodiment performs control of the lighting apparatus, based on the information that is detected by the sound sensor. A lighting control system according to a second embodiment includes an image sensor in addition to the sound sensor, and performs lighting control in which information that is detected by the image sensor is considered.

### Configuration of Lighting Control System According to Second Embodiment

FIG. 6 is a diagram illustrating an example of a configuration of a lighting control system 2 according to the second embodiment. The configuration of the lighting control system 2 is substantially similar to the first lighting control system 1 besides that an image sensor 40 is included. The configurations of a control device 11 and the lighting apparatuses 20A, 20B and 20C are also similar to the first lighting control system 1 besides the following specific description. Moreover, in FIG. 6, one sound sensor 30 and one image sensor 40 are illustrated, but the lighting control system 2 may include a plurality of sound sensors and image sensors.

The image sensor 40 acquires an image of the room which the lighting apparatuses 20A, 20B and 20C illuminate. Image information that is acquired by the image sensor 40 is transmitted to the control device 11. The control device 11 calculates the number of persons in the room, an activity amount in the room or the like, based on the image information that is acquired by the image sensor 40. As a calculating method of the activity amount, based on the image, for example, it is possible to calculate, based on a motion vector of an object in the image with the passage of time. Further, it is also possible to calculate the activity amount by detecting the motion vector in some points which are set in the image in advance. The calculating method of the activity amount is not particularly limited.

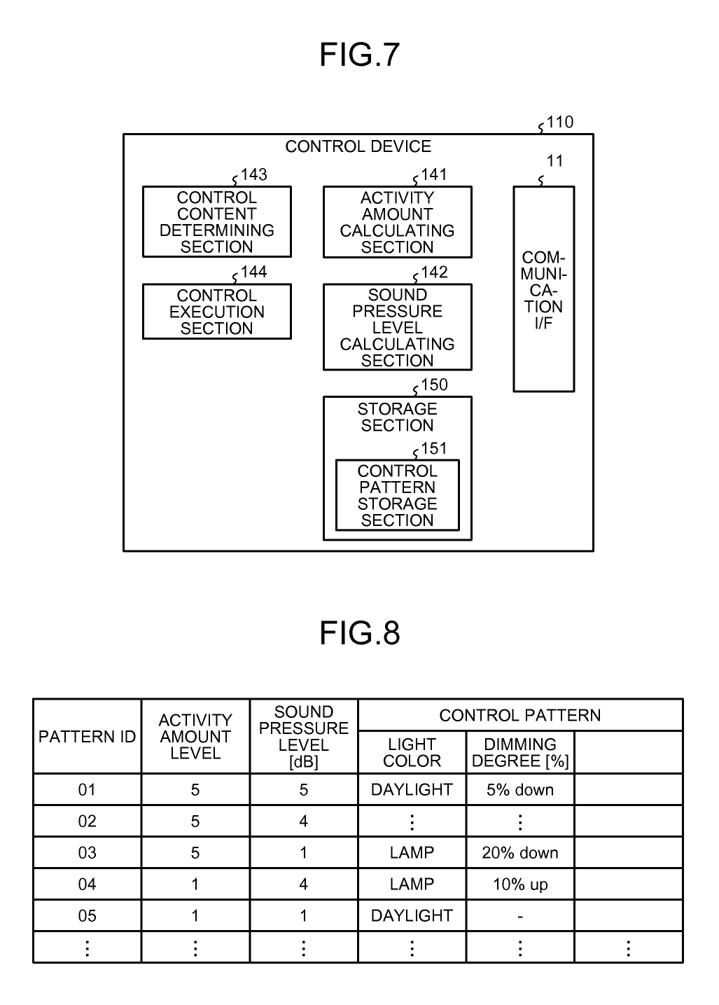

FIG. 7 is a diagram illustrating an example of a configuration of the control device 11 according to the second embodiment. The control device 11 includes the communication interface 110, an activity amount calculating section 141, a sound pressure level calculating section 142, a control content determining section 143, a control execution section 144 and a storage section 150.

The communication interface 110 receives the information from the lighting apparatuses 20A, 20B and 20C, the sound sensor 30, and the image sensor 40, and transmits control instruction to the lighting apparatuses 20A, 20B and 20C.

The activity amount calculating section 141 calculates the activity amount in the room, based on the image information that is received from the image sensor 40. For example, the activity amount calculating section 141 calculates a moving amount of the person in the room or a moving amount of an object besides the person. For example, the activity amount can be displayed by an index such as “an activity amount level 1 (indicating that the activity amount is small)” to “an activity amount level 5 (indicating that the activity amount is great)”. For example, a vector value may be considered to be converted to the activity amount by associating the vector value on the image with the activity amount (calories or the like) of the person. Then, the activity amount of the person in the room which is expected to be generated is estimated in advance and then associated with the levels 1 to 5. The activity amount calculating section 141 calculates the activity amount level, based on the correlation. However, the calculating method of the activity amount by the activity amount calculating section 141 is not particularly limited.

The sound pressure level calculating section 142 calculates the sound pressure level in the room, based on the sound information that is received from the sound sensor 30. The sound pressure level is also set such that “the level 1” is “0 dB to 20 dB”, “the level 5” is “80 dB or more” or the like depending on the sound pressure in the range in which detection is expected as with the case of the activity amount. The sound pressure level calculating section 142 calculates the sound pressure level as the index of “the level 1” to “the level 5” by extracting the person's voice from the sound information that is received from the sound sensor 30. However, the calculating method of the sound pressure level by the sound pressure level calculating section 142 is not particularly limited.

The control content determining section 143 receives the activity amount level and the sound pressure level from the activity amount calculating section 141 and the sound pressure level calculating section 142. Then, the control content determining section 143 determines the control contents of the lighting apparatuses 20A, 20B and 20C, based on the activity amount level and the sound pressure level which are received. For example, a case of the activity amount level 1 and the sound pressure level 1 illustrates that the activity amount is small in the room and there is hardly any person's voice. In this case, for example, the control content determining section 143 determines the control contents to “the daylight” color and the dimming degree “-” (here, “-” means that the dimming degree is not changed) that is the illumination suitable for increasing the concentration. Moreover, a method of the determination of the control contents by the control content determining section 143 is described below in association with a control pattern storage section 151.

The control execution section 144 performs control of the lighting apparatuses 20A, 20B and 20C, based on the control contents which are determined by the control content determining section 143.

The storage section 150 stores the information for the lighting control processing by the control device 11. Particularly, the storage section 150 includes the control pattern storage section 151. The control pattern storage section 151 stores a plurality of control patterns corresponding to the activity amount level and the sound pressure level.

FIG. 8 is a table illustrating an example of a configuration of the information that is stored in the control pattern storage section 151 according to the second embodiment. The control pattern storage section 151 stores the plurality of control patterns corresponding to the activity amount level and the sound pressure level. For example, the control pattern that is specified as the pattern ID “01” is executed when the activity amount level is “5”, that is “great” and the sound pressure level is “5”, that is “great”. In the control pattern of the pattern ID “01”, the lighting control system 2 controls the light color of the lighting apparatus to be “the daylight” color and the dimming degree to be “5% down”. That is, if the activity amount in the room is great and the persons are talking in a loud voice, the illumination for making the person feel cool in the room and for calming sympathetic nerves is considered suitable. Thus, the lighting control system 2 controls the light color to be the daylight color that effectively makes the person feel calm and cool, and controls the brightness to be slightly reduced.

Further, the control pattern of the pattern ID “03” is executed when the activity amount level is “5”, that is “great” and the sound pressure level is “1”, that is “small”. In the control pattern of the pattern ID “03”, the light color of the lighting apparatus is controlled to be “the lamp” color and the dimming degree to be “20% down”. That is, if the activity amount in the room is great and the person in the room is silent, it can be considered that the persons in the room are frustrated and not relaxed. Thus, the lighting control system 2 controls the light color to be “the lamp” color that is effective for giving warm feeling and making people feel relaxed, and controls the brightness to be slightly reduced.

Further, the control pattern of the pattern ID “04” is executed when the activity amount level is “1”, that is “small” and the sound pressure level is “4”, that is “slightly great”. In the control pattern of the pattern ID “04”, the lighting control system 2 controls the light color of the lighting apparatus to be “the lamp” color and the dimming degree to be “10% up”. That is, when the activity amount in the room is small and the persons are talking in a slightly loud voice, a situation may be considered that the persons have discussion sitting in chairs. Thus, the lighting control system 2 controls the light color to be the warm lamp color and the brightness to be raised slightly so as to relax the person and to encourage conversation.

Further, the control pattern of the pattern ID “05” is executed when the activity amount level is “1”, that is “small” and the sound pressure level is “1”, that is “small”. In the control pattern of the pattern ID “05”, the lighting control system 2 controls the light color of the lighting apparatus to be “the daylight” color and the dimming degree is not changed. That is, when the activity amount in the room is small and the voice is also small, a situation may be considered where a person is thinking and the illumination for calm impression may be considered suitable. Thus, the lighting control system 2 controls the light color to be the daylight color that increases the concentration and the dimming degree to be maintained without being changed.

In addition, it is possible to store the patterns of fine lighting control in the control pattern storage section 151 depending on each of the activity amount level and the sound pressure level. For example, it is possible to set the control pattern freely by the user by connecting the information processing device 60 to the control device 11.

### Flow of Lighting Control Processing in Second Embodiment

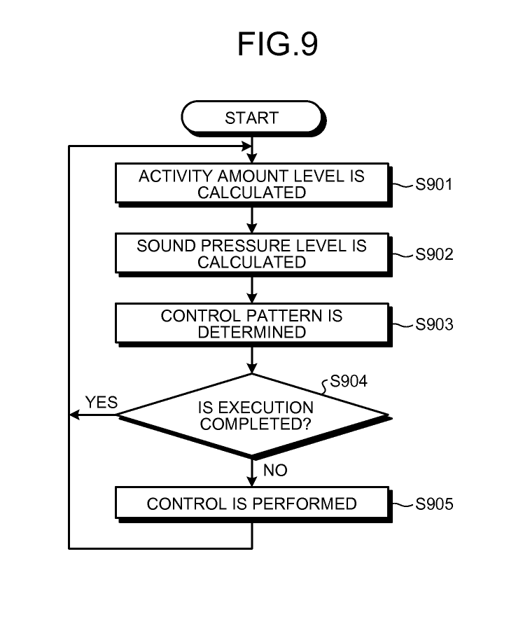

FIG. 9 is a flowchart illustrating an example of a flow of a lighting control processing according to the second embodiment. In the lighting control system 2 according to the second embodiment, first, the image sensor 40 acquires the image and transmits the image to the activity amount calculating section 141. The activity amount calculating section 141 calculates the activity amount level in the room, based on the image that is received (S901).

Thereafter, the sound sensor 30 detects the sound in the room and transmits the sound information that is detected to the sound pressure level calculating section 142. The sound pressure level calculating section 142 calculates the sound pressure level of the person's voice in the room, based on the information that is received (S902). Moreover, here, the sound pressure level calculating section 142 extracts a portion corresponding to the person's voice among the sound that is detected in the room by using the frequency analysis or the like and calculates the sound pressure level.

The activity amount level and the sound pressure level which are calculated are transmitted to the control content determining section 143. The control content determining section 143 determines the control pattern corresponding to the activity amount level and the sound pressure level by referring to the control pattern storage section 151 (S903). Next, the control execution section 144 determines whether or not the control is already executed, based on the control contents which are determined by the control content determining section 143 (S904). If it is determined that the control is already performed (S904, Yes), the control execution section 144 does not take a further process and the processing returns to S901. If it is determined that the control is not yet performed (S904, No), the control execution section 144 performs the control, based on the contents which are determined by the control content determining section 143 (S905). Then, the processing returns to S901, again.

Moreover, in the processing of FIG. 9, a period in which a predetermined activity amount level continues is not considered, but the lighting control may be performed by considering whether or not a predetermined activity amount level continues for a predetermined period, similar to the processing of FIG. 4 according to the first embodiment. For example, if the activity amount level rapidly changes for a short period, the control may not be performed, based on the activity amount level. Then, only if the same activity amount level is detected continuously for a predetermined period, the lighting control may be performed.

Further, in the second embodiment, actual measured values are associated with a plurality of levels in advance with respect to each of the activity amount level and the sound pressure level, and then the control pattern is determined depending on the levels of the activity amount and the sound pressure which are detected. However, the example is not limited to the embodiment and, for example, similar to the first embodiment, a plurality of thresholds are set in advance and then the control contents may be determined by comparing the actual values of the activity amount and the sound pressure to the thresholds. In this case, the configuration of the information stored in the control pattern storage section 151 may be appropriately changed.

Further, in the second embodiment described above, in order to calculate the activity amount of the person in the room, the information that is acquired by the image sensor is used. The example is not limited to the embodiment and other information is extracted from the information that is acquired by the image sensor and may be used in the lighting control. For example, it is possible to use the information by extracting the number of persons in the room from the information that is acquired by the image sensor. As described above, it is possible to calculate the number of persons in the room with high accuracy by combining the extraction of the number of persons by the image sensor with the first embodiment.

### Effect of Second Embodiment

As described above, the lighting control system 2 according to the second embodiment further includes the image sensor 40 that acquires the image in a predetermined space and the control device 11 calculates the activity amount in the predetermined space, based on the image that is acquired by the image sensor 40, and the control of at least one of the light color and the dimming degree of the plurality of lighting apparatuses 20A, 20B and 20C is executed depending on the activity amount and the sound pressure level of the person's voice that is detected by the sound sensor 30. Thus, the lighting control system 2 determines the mood or the situation of the persons in the predetermined space with high accuracy based on the image that is acquired by the image sensor 40. Therefore, it is possible to realize the lighting control suitable for the mood or the situation.

Further, the lighting control system 2 according to the second embodiment further includes the image sensor 40 that acquires the image in the predetermined space and the control device 11 calculates the number of persons in the predetermined space, based on the image that is acquired by the image sensor 40, and controls at least one of the light color and the dimming degree of the plurality of lighting apparatuses 20A, 20B and 20C depending on the number of persons and the sound pressure level of the person's voice that is detected by the sound sensor 30. Thus, the lighting control system 2 can calculate the number of persons with high accuracy compared to a case where the number of persons in the predetermined space is calculated depending on only the information from the sound sensor 30. Therefore, the lighting control system 2 determines the mood or the situation of the persons in the predetermined space. Therefore, it is possible to realize the lighting control suitable for the mood and the situation.

### Third Embodiment

In the lighting control device according to the first embodiment, the dimming control of the lighting apparatus is performed depending on the loudness (the sound pressure level) of the person's voice in the room. Further, in the lighting control system according to the second embodiment, the information (the activity amount) in the room with high accuracy is acquired by the image sensor and the fine control of the lighting apparatus with high accuracy is realized. In the third embodiment, the person's voice in the room is detected and the emotion of the person in the room is estimated by comparing the person's voice to a parameter that is calculated in advance. Then, a lighting control device executes the dimming control of the lighting apparatus depending on the emotion of the person that is estimated.

Usually, the person guesses the emotion of other people from the voice by naturally analyzing the person's voice that is heard. The parameter of the voice indicating a predetermined emotion is extracted by collecting samples of a plurality of person's voices. For example, the samples of the voices indicating the emotion such as anger, joy, sadness, laughter, normal mind or excitement are collected, and a frequency, an amplitude, a waveform or the like of the voice corresponding to each emotion is identified and stored as the parameters.

The lighting control device detects the person's voice in the room by the sound sensor and estimates the emotion of the person in the room by comparing the voice to the parameter that is identified and stored. Then, the lighting control device controls the lighting apparatus in the light color, the dimming degree or the like depending on the emotion of the person that is estimated.

### One Example of Configuration of Lighting Control System According to Third Embodiment

A configuration of a lighting control system 3 according to the third embodiment is similar to that of the lighting control system 1 according to the first embodiment illustrated in FIG. 1. The lighting control system 3 of the third embodiment is different from that of the first embodiment in that a control device 12 is included instead of the control device 10, the control device 12 estimates the emotion of the person in the room based on the information that is acquired by the sound sensors 30A, 30B and 30C, and then the lighting control is performed. Hereinafter, the description is given only to a point that is different from the first and second embodiments, and the description regarding the similar function and configuration is omitted.

A configuration of the control device 12 according to the third embodiment is similar to the configuration of the control device 10 according to the first embodiment. However, a control content determining section 121B included in the control device 12 analyzes voice data that is acquired by the sound sensors 30A, 30B and 30C and estimates the emotion of the person in the room based on the pattern of the parameter for each emotion that is extracted from the sample of the person's voice. The control content determining section 121B determines the control pattern corresponding to the emotion that is estimated from a plurality of control patterns stored in a control pattern storage section 131B included in a storage section 130B. Thereafter, the control device 12 performs control by the control pattern that is determined by the control content determining section 121B.

### Effect of Third Embodiment

As described above, in the lighting control system 3 according to the third embodiment, the control device 12 specifies the emotion indicated by the voice, based on at least one of the frequency, the amplitude and the waveform of the person's voice that is detected by the sound sensors 30A, 30B and 30C, and performs control of at least one of the light color and the dimming degree of the plurality of lighting apparatuses 20A, 20B and 20C depending on the specified emotion. Thus, the lighting control system 3 accurately determines the emotion of the person in a predetermined space based on the voice. It is possible to realize the lighting control suitable for the emotion of the person present in the room.

As described above, according to the lighting control system of the embodiments, it is possible to realize the lighting control suitable for the number, mood, atmosphere or the like of persons present in the room.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A lighting control system comprising:
a plurality of lighting apparatuses that illuminate a predetermined space;
a sound sensor that is disposed in the predetermined space and detects a voice of a person in the space; and
a control device that is connected to the plurality of lighting apparatuses and the sound sensor, and controls at least one of a light color and a dimming degree of the plurality of lighting apparatuses depending on quality of the voice of the person that is detected by the sound sensor.

2. The system according to claim 1,
wherein the control device performs control of at least one of the light color and the dimming degree of the plurality of lighting apparatuses, when a sound pressure level of the voice of the person that is detected by the sound sensor is a predetermined value continuously for a predetermined period.

3. The system according to claim 1,
wherein the control device performs control to lower the dimming degree of the plurality of lighting apparatuses, when the sound pressure level of the voice of the person that is detected by the sound sensor is smaller than a first threshold, and performs control to increase the dimming degree of the plurality of lighting apparatuses, when the sound pressure level of the voice of the person that is detected by the sound sensor is greater than a second threshold that is greater than the first threshold.

4. The system according to claim 3,
wherein the control device performs control to lower a color temperature of the light color of the plurality of lighting apparatuses, and to lower the dimming degree of the plurality of lighting apparatuses when the sound pressure level of the voice of the person that is detected by the sound sensor is greater than a third threshold that is greater than the second threshold.

5. The system according to claim 1,
wherein the control device calculates a number of persons present in the predetermined space from the voice of the person that is detected by the sound sensor and controls at least one of the light color and the dimming degree of the plurality of lighting apparatuses based on the sound pressure level of the voice and the number of persons that is calculated.

6. The system according to claim 1, further comprising:
an image sensor that acquires an image in the predetermined space,
wherein the control device calculates an activity amount in the predetermined space, based on the image that is acquired by the image sensor, and controls at least one of the light color and the dimming degree of the plurality of lighting apparatuses, depending on the activity amount and the sound pressure level of the voice of the person that is detected by the sound sensor.

7. The system according to claim 1, further comprising:
an image sensor that acquires an image in the predetermined space,
wherein the control device calculates a number of persons in the predetermined space, based on the image that is acquired by the image sensor, and controls at least one of the light color and the dimming degree of the plurality of lighting apparatuses, depending on the number of persons and the sound pressure level of the voice of the person that is detected by the sound sensor.

8. The system according to claim 1,
wherein the control device specifies emotion indicated by the voice, based on at least one of a frequency, an amplitude and a waveform of the voice of the person that is detected by the sound sensor, and performs control of at least one of the light color and the dimming degree of the plurality of lighting apparatuses, depending on the specified emotion.
